(19) United States
(12) Patent Application Publication
(10) Pub. No.: US 2026/0313454 A1
(43) Pub. Date: Oct. 8, 2026

(54) PROHIBIT TIMER FOR RADIO LINK CONTROL PROTOCOL DATA UNIT RETRANSMISSION

(71) Applicant: QUALCOMM Incorporated, San Diego, CA (US)

(72) Inventors: Linhai HE, San Diego, CA (US); Sitaramanjaneyulu KANAMARLAPUDI, San Diego, CA (US)

(21) Appl. No.: 19/576,301

(22) Filed: Mar. 24, 2026

Related U.S. Application Data
(60) Provisional application No. 63/782,118, filed on Apr. 2, 2025.

(51) Int. Cl. H04W 28/04; H04L 1/1812; H04L 5/00

(52) U.S. Cl. CPC H04W 28/04; H04L 1/1812; H04L 5/0053

(57) ABSTRACT

Certain aspects of the present disclosure provide techniques for wireless communications. An example method includes receiving, at a radio link control (RLC) layer, an RLC service data unit (SDU); providing an initial transmission of an RLC PDU, including the RLC SDU, wherein providing the RLC PDU is associated with a start of a prohibit timer; and providing, autonomously and after a termination of the prohibit timer, a retransmission of the RLC PDU.

### CROSS-REFERENCE TO RELATED APPLICATION(S)

The present Application for Patent claims benefit of U.S. Provisional Application No. 63/782,118, filed Apr. 2, 2025, which is hereby expressly incorporated by reference herein in its entirety.

### INTRODUCTION

### Field of the Disclosure

Aspects of the present disclosure relate to wireless communications, and more particularly, to techniques for a prohibit timer for radio link control protocol data unit retransmission.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes receiving, at a radio link control (RLC) layer, an RLC service data unit (SDU); providing an initial transmission of an RLC PDU, including the RLC SDU, wherein providing the RLC PDU is associated with a start of a prohibit timer; and providing, autonomously and after a termination of the prohibit timer, a retransmission of the RLC PDU.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example control plane protocol stack and an example user plane protocol stack.

FIG. 6 is a diagram illustrating an example of a data flow through layers of a UE.

FIG. 7 is a diagram illustrating an example of autonomous radio link control (RLC) retransmission using a prohibit timer and a retransmission timer.

FIG. 8 is a diagram illustrating an example of operation of a retransmission timer and a prohibit timer.

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for a prohibit timer for radio link control protocol data unit retransmission.

A wireless communication technology, such as 5G/New Radio (NR), may implement data communication using a hierarchical set of protocol layers. Data may flow from higher layers to lower layers during transmission, and from lower layers to higher layers during reception. A user equipment (UE) or a network entity may implement multiple layers, including (from lower layer to higher layer) a physical layer, a medium access control (MAC) layer, and a radio link control (RLC) layer. The RLC layer generally handles segmentation and reassembly of data that is received from a higher layer as an RLC service data unit (SDU). The RLC layer passes the processed RLC SDUs, as RLC PDUs, to the MAC layer for processing (such as multiplexing and management of hybrid automatic repeat request (HARQ) operation). The MAC layer receives the RLC PDUs as MAC SDUs and passes the processed MAC SDUs to the physical (PHY) layer as transport blocks (or physical layer SDUs). The PHY layer may perform code block segmentation, and may transmit the data to a receiver. Thus, an SDU represents data received from an upper layer, while a PDU is the processed data unit prepared for transfer to a lower layer. Thus, an RLC PDU becomes a MAC SDU, and similarly, a MAC PDU becomes a PHY SDU. This encapsulation process allows each layer to perform its specialized functions while maintaining protocol independence. A UE may implement the RLC layer at an RLC entity and the MAC layer at a MAC entity.

As mentioned, a MAC entity may implement HARQ. HARQ is a mechanism that facilitates retransmission of data, by combining forward error correction with error detection and retransmission. A receiver may receive a data transmission. If the receiver detects an error in the transmission and thus cannot successfully process the transmission, the receiver may request a retransmission of the transmission. The receiver may then combine the initial transmission and the retransmission, which increases the likelihood of successful decoding. HARQ may operate with regard to a MAC SDU. That is, upon receiving an RLC PDU from the RLC layer, the MAC entity may prepare a MAC PDU for transmission, and may administer HARQ with regard to the MAC PDU.

Separately from HARQ, the UE's RLC entity may use a poll and status report mechanism (referred to as an automatic repeat request (ARQ) mechanism, which may be implemented in RLC acknowledged mode (AM)) to determine whether RLC PDUs are successfully transmitted. The transmitting RLC entity can set a poll bit in an outgoing RLC PDU (referred to as a poll message), requesting the receiving entity to provide status information. Upon receiving this poll, a receiver may generate a status report containing acknowledgment information for received RLC PDUs, including which PDUs have been successfully received and which remain outstanding. The receiver may transmit the status report to the UE, and the RLC entity of the UE may identify any missed RLC PDUs according to the status report. If the status report does not acknowledge the successful reception of a given RLC PDU, the RLC entity resends the RLC PDU by providing the RLC PDU again to the MAC entity. These steps are repeated until the RLC PDU is successfully received or a configured maximum number of retransmissions is reached (at which point the transmitter aborts attempts to transmit the RLC PDU).

The network may generally configure only a limited number of HARQ retransmissions. This is resource efficient in a situation where HARQ failure occurs with low probability. However, configuring a limited number of HARQ retransmissions may create delay for a given RLC PDU. This is because each RLC ARQ transmission may take longer than a HARQ process, since each RLC ARQ transmission may have to move through uplink access and two HARQ transmissions (due to a round trip on both the downlink and the uplink). This delay may be problematic for many forms of wireless communication, and in particular, delay-sensitive wireless communications (such as extended reality (XR) traffic). Thus, RLC AM (e.g., the RLC ARQ mechanism) may cause failure of delay-sensitive communications and lower throughput.

Aspects of the present disclosure relate generally to autonomous retransmission of RLC PDUs. Some aspects more specifically provide for an RLC entity to trigger retransmission of an RLC PDU autonomously (such as without a status report indicating an unreceived RLC PDU). Some aspects described herein provide a prohibit timer, which indicates a minimum length of time. After the prohibit timer has elapsed or been canceled (for example, based on receiving a negative acknowledgment (NACK) for the RLC PDU), the RLC entity is allowed to trigger retransmission of the RLC PDU. Some aspects described herein combine the prohibit timer with a retransmission timer. The retransmission timer may be based on a delay budget of an RLC SDU. For example, the retransmission timer may be configured to trigger retransmission of an RLC PDU (including the RLC SDU) once a remaining time of the retransmission timer is lower than a threshold. In some examples, the threshold may be based on a round trip time of the RLC PDU. Thus, the UE may trigger retransmission of an RLC PDU according to the retransmission timer, but only if the prohibit timer permits retransmission of the RLC PDU.

Aspects of the present disclosure may be used to realize one or more of the following potential advantages. By providing autonomous retransmission of RLC PDUs according to the prohibit timer, the UE is permitted to retransmit an RLC PDU on a shorter timescale than relying on RLC AM for retransmission, which improves reliability and reduces failure of delay-sensitive communications. By implementing the prohibit timer, overhead is reduced and resource efficiency is improved relative to a situation where the UE is permitted to indiscriminately retransmit RLC PDUs. By implementing the retransmission timer, the UE is triggered to autonomously retransmit an RLC PDU carrying an RLC SDU before a delay budget of the RLC SDU has elapsed, thereby reducing delay.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

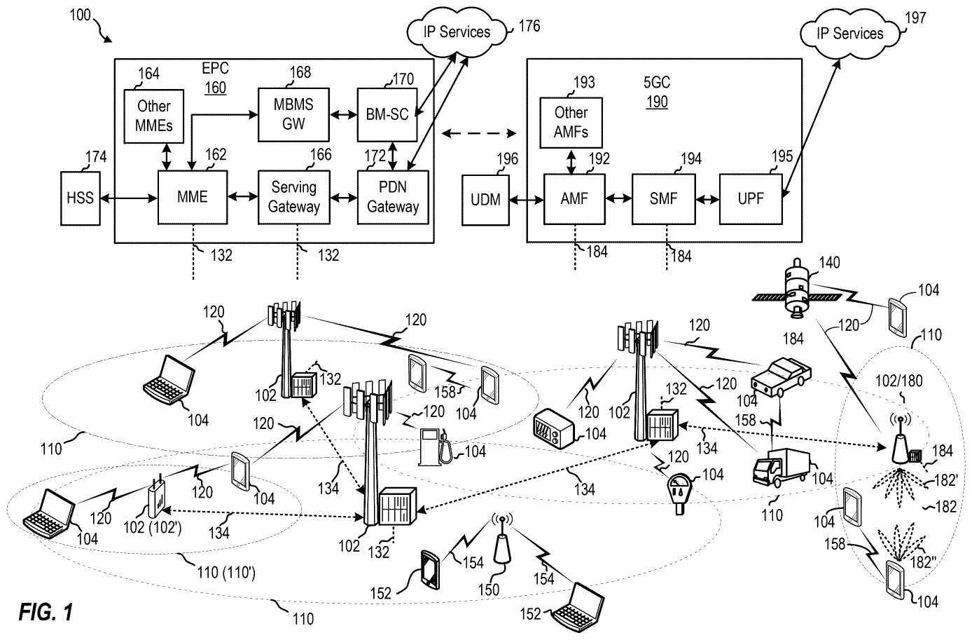

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smartphone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always-on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) that may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

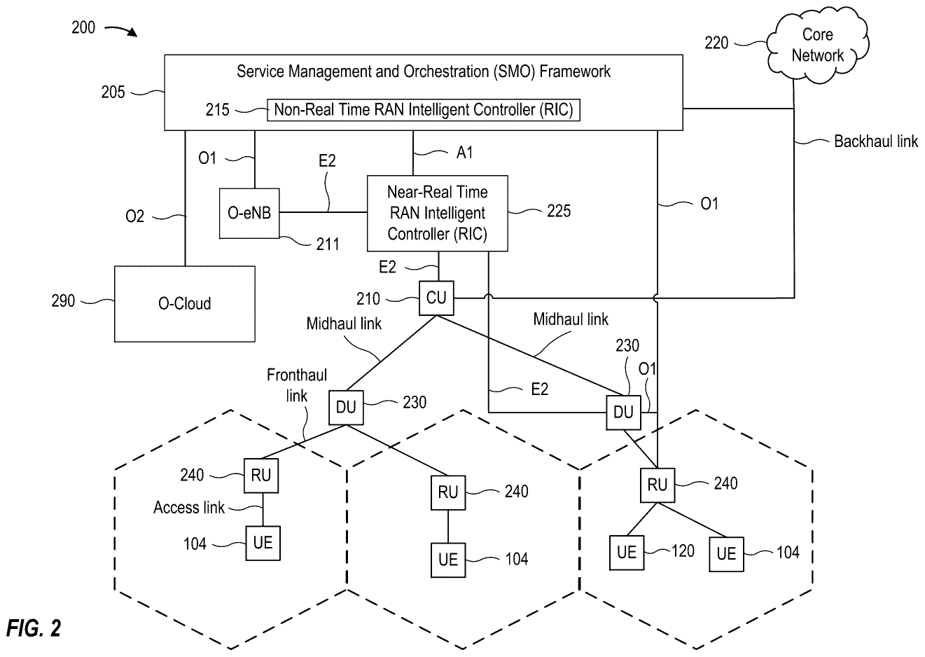

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications link 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving Gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS-related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher-layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over-the-air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

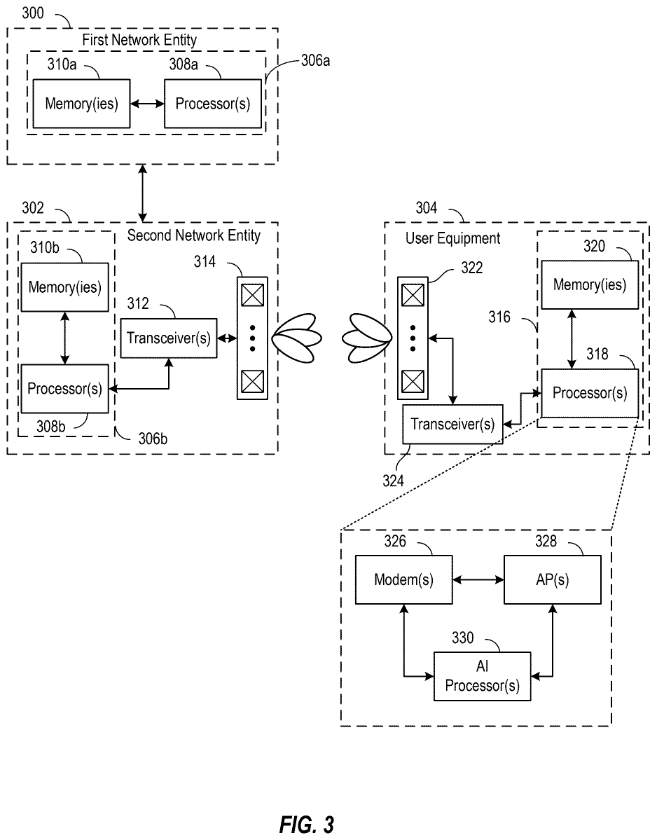

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASICs), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware-accelerated AI inferences and/or AI training. In some cases, at the second network entity 302, the AI processor may decode compressed CSF from the UE 304, for example, using a hardware-accelerated AI inference associated with the CSF. In certain cases, the AI processor may perform certain RAN-based functions including, for example, network planning, network performance management, energy-efficient network operations, etc.

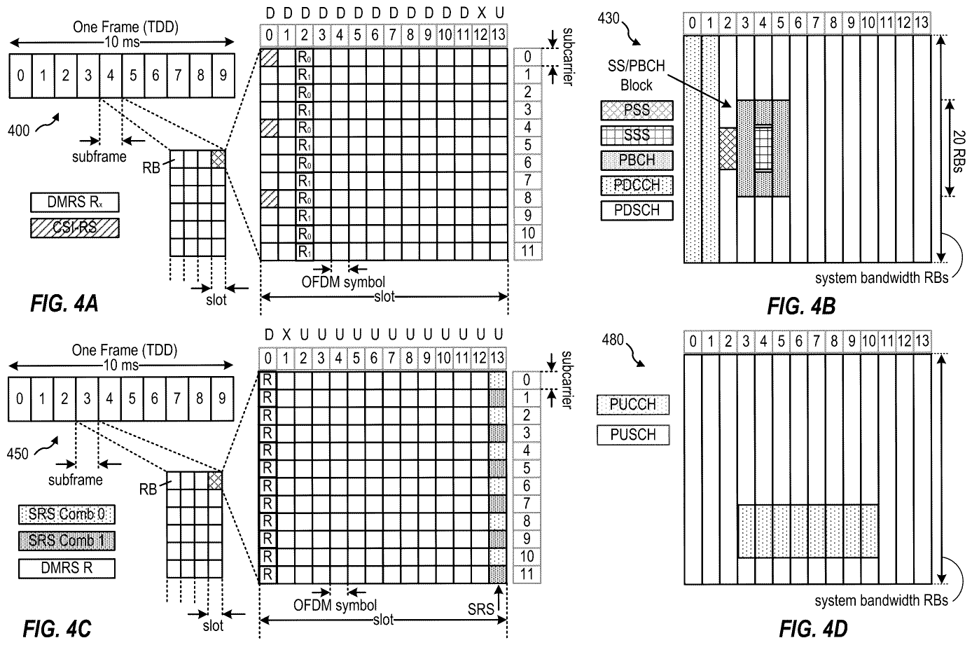

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signal (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

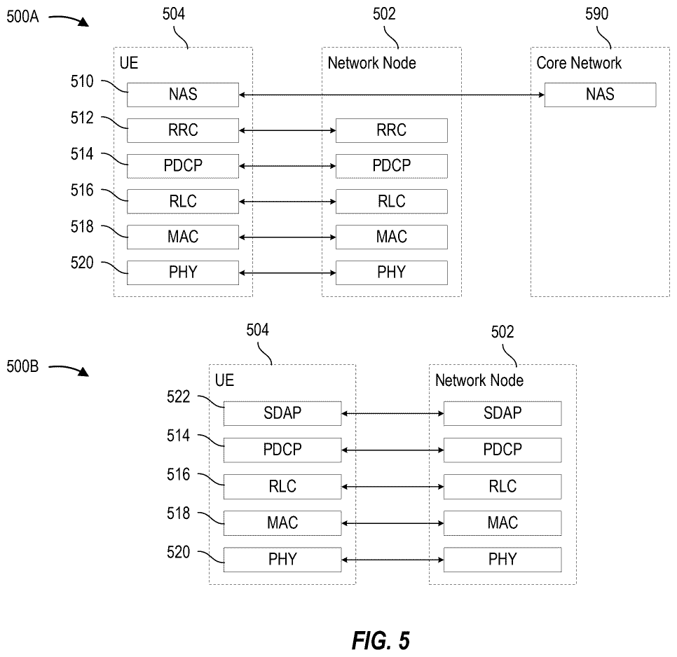

FIG. 5 depicts an example control plane protocol stack 500A for exchanging control plane traffic (e.g., control signaling) between a user equipment (UE) 504 and a network node 502, and between the UE 504 and a core network 590. In some aspects, the network node 502 may be an example of the BS and/or network entities depicted and described with respect to FIGS. 1 and 3 or a disaggregated base station depicted and described with respect to FIG. 2. Similarly, the UE 504 may be an example of UE depicted and described with respect to FIGS. 1 and 3. The core network 590 may be an example of the 5GC network 190 and/or the core network 220 depicted and described with respect to FIGS. 1 and 2, respectively.

The control plane protocol stack 500A includes a non-access stratum (NAS) layer 510, a radio resource control (RRC) layer 512, a packet data convergence protocol (PDCP) layer 514, a radio link control (RLC) layer 516, a medium access control (MAC) layer 518, and a physical (PHY) layer 520. The NAS layer 510 carries mobility management and session management signaling between the UE 504 and the core network 590 (e.g., the AMF 192 and/or the SMF 194 of FIG. 1). The RRC layer 512 carries RRC signaling, for example, for paging, RRC connection establishment, RRC connection reconfiguration, and RRC connection release. The PDCP layer 514 provides ciphering and integrity protection for control plane signaling. The RLC layer 516 may segment a large packet into smaller packets and handles re-transmissions of RLC packets. According to aspects described herein, the RLC layer may track a retransmission timer and/or a prohibit timer, and may autonomously retransmit RLC packets (e.g., RLC PDUs) according to the prohibit timer and/or the retransmission timer.

The MAC layer 518 schedules transmissions between the UE 504 and the network node 502 and controls the PHY layer. In the MAC layer 518, the UE 504 and the network node 502 may communicate with each other by exchanging a MAC control element (MAC-CE). The PHY layer 520 handles transmission and reception across the air-interface between the UE 504 and the network node 502. The PHY layer 520 provides certain error management tasks (e.g., cyclic redundancy check), certain digital signaling processing tasks (e.g., modulation and demodulation), and handles certain procedures for measurement and control (e.g., beam failure detection and/or radio link monitoring). The network node 502 may send, to the UE 504, PHY layer signaling via downlink control information (DCI).

FIG. 5 also depicts an example user plane protocol stack 500B for exchanging user plane traffic (e.g., application data) between the UE 504 and the network node 502. The user plane protocol stack 500B includes a service data adaptation protocol (SDAP) layer 522, the PDCP layer 514, the RLC layer 516, the MAC layer 518, and the PHY layer 520. The SDAP layer 522 maps the quality of service (QoS) flow(s) used at the core network 590 (e.g., for a protocol data unit (PDU) session) to data radio bearer(s) used at the network node 502 to communicate via an air-interface between the UE 504 and the network node 502. In the user plane, the PDCP layer 514 provides packet header compression (e.g., transmission control protocol (TCP), user datagram protocol (UDP), and/or internet protocol (IP) header compression), ciphering, and integrity protection for user plane traffic.

The RRC layer 512 may form Layer-3 (L3) of the control plane protocol stack 500A. In the user plane, the SDAP layer 522, the PDCP layer 514, the RLC layer 516, and/or the MAC layer 518 may form Layer-2 (L2) of the user plane protocol stack 500B. In the control plane, the PDCP layer 514, the RLC layer 516, and/or the MAC layer 518 may form L2 of the control plane protocol stack 500A. The PHY layer 520 may form Layer-1 (L1) of the protocol stacks 500A, 500B. Layer-3 may include the highest or upper layers in the control plane protocol stack 500A; Layer-2 may include the intermediate layers in the control plane protocol stack 500A, where Layer-2 is arranged between Layer-3 and Layer-1; and Layer-1 may include the lowest layer in the control plane protocol stack 500A.

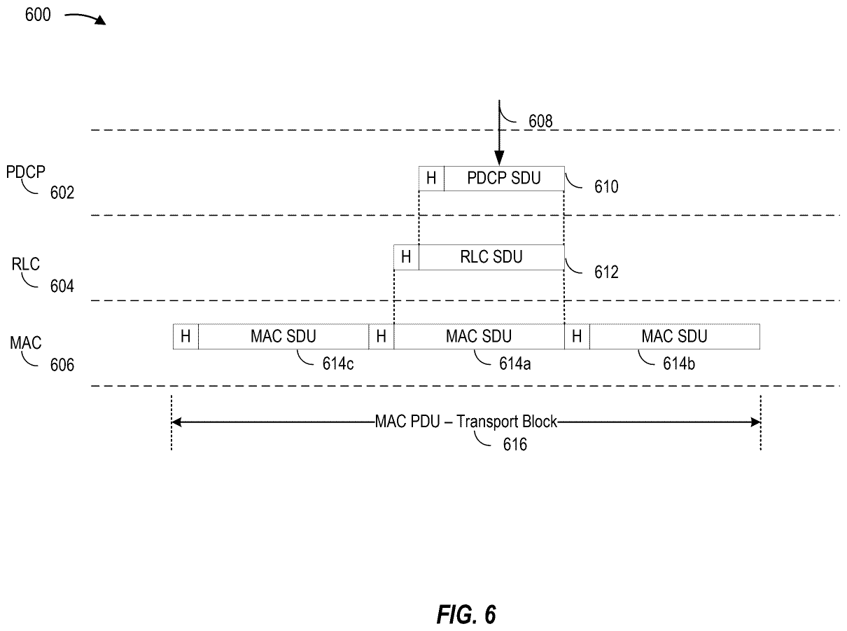

FIG. 6 is a diagram illustrating an example 600 of a data flow through layers of a UE. The protocol layers illustrated in FIG. 6 include a PDCP layer 602, an RLC layer 604, and a MAC layer 606. The PDCP layer 602 may be implemented by a PDCP entity at a UE, such as UE 104 or UE 304. The RLC layer 604 may be implemented by an RLC entity at the UE. The MAC layer 606 may be implemented by a MAC entity at the UE. Operations described herein as being performed by a UE may be performed by one or more of these entities, or by a PHY entity of the UE. Operations described herein as being performed by a protocol layer of the UE (e.g., “the RLC layer may process”) may be performed by the corresponding protocol entity (e.g., “the RLC entity may process”), and vice versa.

At 608, the PDCP entity receives, from a higher layer (such as an SDAP layer), a PDCP SDU 610. The PDCP entity processes the PDCP SDU 610 as described with respect to FIG. 5, and adds a header (denoted “H”) to the PDCP SDU 610. Thus, the PDCP entity creates a PDCP PDU that includes or is based on the PDCP SDU. The PDCP entity provides the PDCP PDU to the RLC entity, and the RLC entity receives the PDCP PDU as an RLC SDU 612. According to aspects herein, upon receiving the RLC SDU 612, the RLC entity may start a retransmission timer associated with (e.g., specific to) the RLC SDU 612.

The RLC entity processes the RLC SDU 612 as described with respect to FIG. 5, and adds a header to the RLC SDU. The RLC entity provides the RLC SDU 612 to the MAC entity as a MAC SDU 614a. The MAC entity processes the MAC SDU 614a as described with respect to FIG. 5, and adds a header to the MAC SDU 614a. The MAC SDU 614a (and the header) may be combined with one or more other MAC SDUs 614b, 614c to form a MAC PDU 616 (also referred to as a transport block). The MAC entity may provide the MAC PDU 616 to a PHY layer for transmission. The MAC entity may perform a HARQ process with regard to the MAC PDU 616. For example, the MAC entity may receive and process HARQ feedback that indicates whether the MAC PDU 616 was successfully received. If the MAC entity receives a negative acknowledgment (NACK) (or does not receive an ACK) for the MAC PDU 616, the MAC entity may retransmit at least part of the MAC PDU 616. This may continue for a scheduled or configured number of HARQ retransmissions. If, after the scheduled or configured number of HARQ retransmissions, transmission of at least part of the MAC PDU 616 is still unsuccessful, the MAC entity may drop the at least part of the MAC PDU 616.

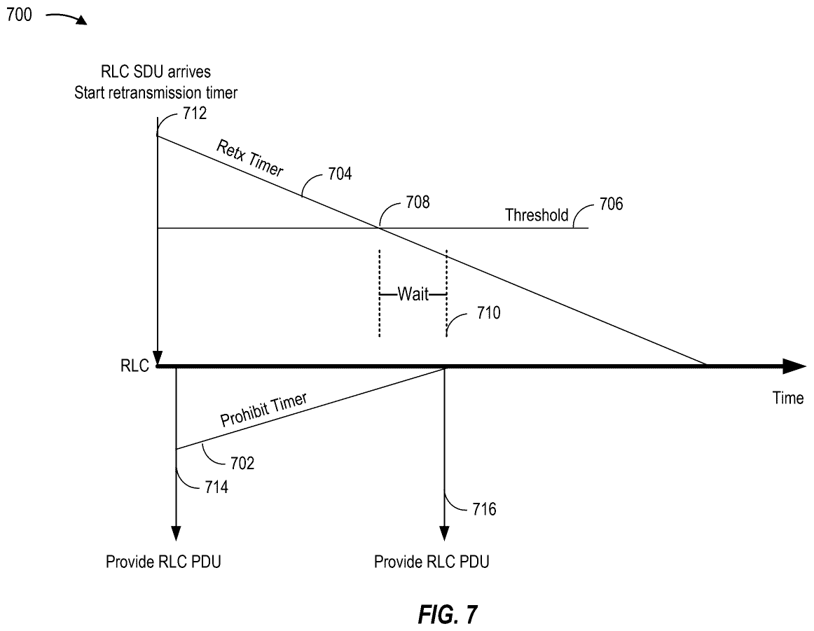

FIG. 7 is a diagram illustrating an example 700 of autonomous RLC retransmission using a prohibit timer and a retransmission timer. The operations of example 700 may be performed by a transmitter, such as a UE 104/304 or a network entity 300/302. In some aspects, the operations of example 700 may be performed by an RLC entity of a UE (e.g., an RLC entity corresponding to RLC layer 604 or RLC layer 516).

Example 700 includes a prohibit timer 702. In some aspects, the prohibit timer 702 is optional. A prohibit timer 702 may be maintained at the RLC entity. A prohibit timer 702 may indicate a length of time, after providing a given RLC PDU (e.g., the RLC PDU formed from RLC SDU 612) for transmission, during which the PDCP entity is not allowed to trigger retransmission of the given RLC PDU. For example, while the prohibit timer 702 is active (e.g., not terminated), the RLC entity may not be permitted to provide the given RLC PDU to the MAC layer for retransmission.

In some aspects, a time length of the prohibit timer 702 may be based on a time required to complete a HARQ process. For example, the time length of the prohibit timer 702 may be based on a HARQ process time from transmitting a signal to receiving HARQ feedback regarding the signal, or to completing a number of HARQ retransmissions regarding the signal. Thus, it may be expected that, once the prohibit timer 702 has expired, a HARQ process has been attempted and likely completed.

The prohibit timer 702 may terminate at an end of a time length of the prohibit timer 702. The prohibit timer 702 may also terminate after the given RLC PDU has failed a number of HARQ transmissions or retransmissions. In some aspects, the transmitter may be configured with the number of HARQ transmissions or retransmissions. Thus, if transmission of the given RLC PDU has failed a number of times, or if a length of time has passed after initial transmission of the given RLC PDU, the RLC entity is permitted to trigger retransmission of the given RLC PDU according to the prohibit timer.

Example 700 also includes a retransmission timer 704 and a threshold 706. The retransmission timer 704 may trigger or control retransmission of the RLC PDU. For example, the transmitter may trigger retransmission of the RLC PDU (by providing the RLC PDU from the RLC entity to the MAC entity) when or after a remaining time of the retransmission timer 704 satisfies (e.g., is lower than, is lower than or equal to) the threshold 706, as illustrated at 708. However, in example 700, the prohibit timer 702 has not yet terminated at 708, so the RLC entity waits until a time illustrated by 710 (a termination of the prohibit timer 702) to trigger the retransmission of the RLC PDU. Thus, overhead is reduced relative to a situation where the RLC entity can trigger the retransmission without regard for the prohibit timer 702.

In some aspects, a time length of the retransmission timer 704 may be based on a round trip time of an RLC PDU from a time the RLC PDU is transmitted from the transmitter, to an estimated time for the status report corresponding to the RLC PDU to arrive. In some aspects, a time length of the retransmission timer 704 may be shorter than a delay budget of the RLC PDU (or the RLC SDU encapsulated in the RLC PDU). In some aspects, given an RLC PDU with a delay budget of 30 ms and a round trip time of 10 ms (e.g., a round trip time of the RLC layer), the retransmission timer 704 (based on the threshold 706) may be configured to trigger retransmission of the RLC PDU at a time of 20 ms after arrival of the corresponding RLC SDU, which improves the likelihood that the RLC PDU can be successfully transmitted within the delay budget, taking into account the round trip time. In some aspects, the retransmission timer 704 may be terminated if the transmitter receives a positive acknowledgment for the RLC SDU, such that no further retransmission of the RLC SDU is attempted.

As shown at 712, the RLC entity may start the retransmission timer 704 upon arrival of an RLC SDU at the RLC entity. The retransmission timer 704 may be associated with (e.g., specific to) the RLC SDU. As shown at 714, the RLC entity provides an RLC PDU based on (e.g., encapsulating) the RLC SDU. The RLC entity starts the prohibit timer 702 upon providing the RLC PDU. The prohibit timer 702 may be associated with (e.g., specific to) the RLC PDU. As shown at 716, once the prohibit timer 702 has terminated and the retransmission timer 704 satisfies the threshold 706, the RLC entity may trigger retransmission of the RLC SDU by providing the RLC PDU to the MAC entity. As mentioned, the RLC entity may not be allowed to perform the retransmission if the prohibit timer 702 is running, and may hold the retransmission until the prohibit timer 702 has terminated (based on the length of time or cancelling the prohibit timer 702).

In some aspects, the transmitter may receive configuration information that indicates one or more of a length of the prohibit timer 702, a length of the retransmission timer 704, a number of HARQ transmissions or retransmissions after which to terminate the prohibit timer 702, a value of the threshold 706, or a delay budget or round trip time that can be used to calculate the prohibit timer 702 or the retransmission timer 704. In some aspects, the transmitter may determine the length of the prohibit timer 702 or the retransmission timer 704.

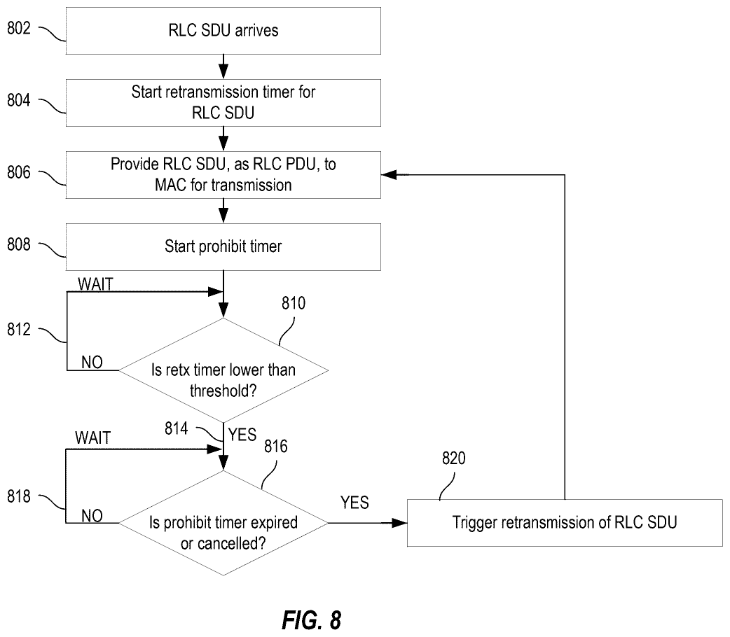

FIG. 8 is a diagram illustrating an example 800 of operation of a retransmission timer (e.g., retransmission timer 704) and a prohibit timer (e.g., prohibit timer 702). The operations of FIG. 8 may be performed by an RLC entity of a transmitter, such as UE 104/304 or network entity 300/302.

At 802, an RLC SDU arrives at the RLC entity. At 804, the RLC entity starts the retransmission timer for the RLC SDU. For example, the RLC entity may run a respective retransmission timer for each of multiple RLC SDUs received at the RLC entity. At 806, the RLC entity provides the RLC SDU, as an RLC PDU (e.g., enclosed in an RLC PDU, with a header attached), to the MAC entity for transmission. The MAC entity may provide the RLC PDU to the PHY layer for transmission, and the transmitter may transmit the RLC PDU (e.g., in a transport block). At 808, the RLC entity starts a prohibit timer for the RLC PDU. For example, the RLC entity may start the prohibit timer upon providing the RLC PDU to the MAC entity for transmission. In some aspects, the prohibit timer is for the RLC PDU. For example, the RLC entity may run a respective retransmission timer for each of multiple RLC SDUs provided by the RLC entity to the MAC entity.

At 810, the RLC entity may determine whether the retransmission timer satisfies (e.g., is lower than) a threshold (e.g., threshold 706). If the retransmission timer does not satisfy the threshold (block 810—NO), then the RLC entity may wait until the retransmission timer satisfies the threshold, as illustrated at 812. If the retransmission timer satisfies the threshold (block 810—YES, as illustrated at 814), then the RLC entity may determine whether the prohibit timer is terminated (e.g., expired or cancelled) at 816.

If the prohibit timer is not terminated (block 816—NO), then the RLC entity may wait until the prohibit timer is terminated, as illustrated at 818. If the prohibit timer is terminated (block 816—YES) while the retransmission timer satisfies the threshold, then the RLC entity may trigger retransmission of the RLC SDU (by providing the RLC SDU in the RLC PDU to the MAC entity for transmission) at 820. In some aspects, the RLC entity may provide the retransmission of the RLC PDU autonomously (that is, without having transmitted a poll message for the RLC SDU, without having received a NACK for the RLC PDU, without having received a status report that omits the RLC PDU, before having received a status report for the RLC PDU, or a combination thereof). The MAC entity may provide the RLC PDU to the PHY layer for transmission, and the transmitter may transmit the RLC PDU (e.g., in a transport block). Thus, the RLC entity may return to block 806. This may continue until the retransmission timer is terminated based on a length of time of the retransmission timer elapsing or the transmitter receiving an RLC acknowledgment (e.g., based on a status report) for the RLC SDU or the RLC PDU.

### Example Operations of a User Equipment

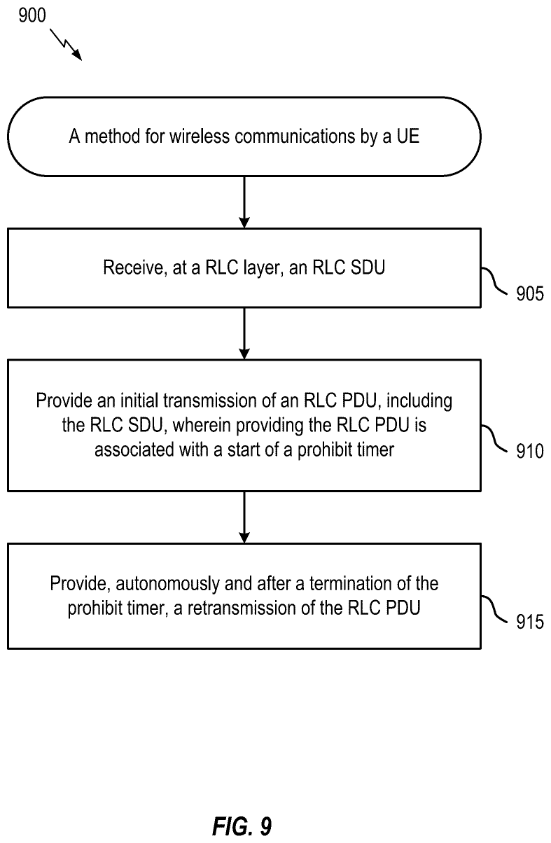

FIG. 9 shows a method 900 for wireless communications by a UE, such as UE 104 of FIG. 1 or UE 304 of FIG. 3.

Method 900 begins at block 905 with receiving, at a RLC layer, an RLC SDU.

Method 900 then proceeds to block 910 with providing an initial transmission of an RLC PDU, including the RLC SDU, wherein providing the RLC PDU is associated with a start of a prohibit timer.

Method 900 then proceeds to block 915 with providing, autonomously and after a termination of the prohibit timer, a retransmission of the RLC PDU.

In some aspects, block 915 includes providing the retransmission based on remaining time of a retransmission timer being lower than a threshold.

In some aspects, block 915 includes providing the retransmission without having received a negative acknowledgment for the RLC PDU.

In some aspects, block 915 includes providing the retransmission without having transmitted a poll message for the RLC PDU.

In some aspects, method 900 further includes starting the retransmission timer upon receiving the RLC SDU at the RLC layer.

In some aspects, the retransmission timer is associated with a delay budget of the RLC SDU.

In some aspects, the threshold is associated with a HARQ process time of the UE.

In some aspects, block 915 includes waiting until the termination of the prohibit timer, while the remaining time of the retransmission timer is lower than the threshold, to provide the retransmission of the RLC PDU.

In some aspects, the retransmission timer is specific to the RLC SDU.

In some aspects, method 900 further includes canceling the retransmission timer in accordance with a positive acknowledgment of the RLC SDU.

In some aspects, method 900 further includes terminating the prohibit timer in accordance with a number of HARQ failures satisfying a second threshold.

In some aspects, the prohibit timer is specific to the RLC PDU.

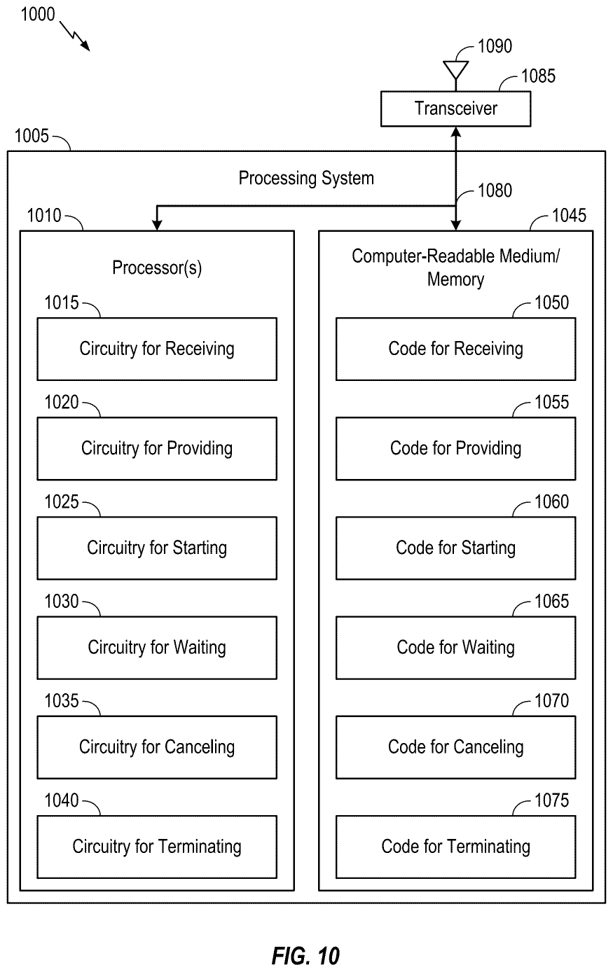

In some aspects, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative operations are possible consistent with this disclosure.

### Example Communications Device

FIG. 10 depicts aspects of an example communications device 1000 configured for wireless communications. In some aspects, communications device 1000 is a user equipment, such as UE 104 described above with respect to FIG. 1 or UE 304 described with respect to FIG. 3.

The communications device 1000 includes a processing system 1005 coupled to a transceiver 1085 (e.g., a transmitter and/or a receiver). The transceiver 1085 is configured to transmit and receive signals for the communications device 1000 via an antenna 1090, such as the various signals as described herein. The processing system 1005 may be configured to perform processing functions for the communications device 1000, including processing signals received and/or to be transmitted by the communications device 1000.

The processing system 1005 includes one or more processors 1010 and a computer-readable medium/memory 1045. In various aspects, the one or more processors 1010 may be representative of the one or more processors 318 described with respect to FIG. 3. The one or more processors 1010 are coupled to a computer-readable medium/memory 1045 via a bus 1080. In some aspects, the computer-readable medium/memory 1045 may be representative of the one or more memories 320 described with respect to FIG. 3. The computer-readable medium/memory 1045 is a non-transitory computer-readable medium/memory. In certain aspects, the computer-readable medium/memory 1045 is configured to store instructions (e.g., computer-executable code), that when executed by the one or more processors 1010, cause the one or more processors 1010 to perform the method 900 described with respect to FIG. 9, or any aspect related to it, including any operations described in relation to FIG. 9. Note that reference to a processor performing a function of communications device 1000 may include one or more processors performing that function of communications device 1000, such as in a distributed fashion.

In the depicted example, computer-readable medium/memory 1045 stores code (e.g., executable instructions), including code for receiving 1050, code for providing 1055, code for starting 1060, code for waiting 1065, code for canceling 1070, and code for terminating 1075. Processing of the code 1050-1075 may enable and cause the communications device 1000 to perform the method 900 described with respect to FIG. 9, or any aspect related to it. For instance, in some aspects, code for receiving 1050 includes code for receiving, at a RLC layer, an RLC SDU. In some aspects, code for providing 1055 includes code for providing an initial transmission of an RLC PDU, including the RLC SDU, wherein providing the RLC PDU is associated with a start of a prohibit timer. In some aspects, code for providing 1055 includes code for providing, autonomously and after a termination of the prohibit timer, a retransmission of the RLC PDU.

The one or more processors 1010 include circuitry configured to implement (e.g., execute) the code stored in the computer-readable medium/memory 1045, including circuitry for receiving 1015, circuitry for providing 1020, circuitry for starting 1025, circuitry for waiting 1030, circuitry for canceling 1035, and circuitry for terminating 1040. Processing with circuitry 1015-1040 may enable and cause the communications device 1000 to perform the method 900 described with respect to FIG. 9, or any aspect related to it. For instance, in some aspects, circuitry for receiving 1015 includes circuitry for receiving, at a RLC layer, an RLC SDU. In some aspects, circuitry for providing 1020 includes circuitry for providing an initial transmission of an RLC PDU, including the RLC SDU, wherein providing the RLC PDU is associated with a start of a prohibit timer. In some aspects, circuitry for providing 1020 includes circuitry for providing, autonomously and after a termination of the prohibit timer, a retransmission of the RLC PDU.

More generally, means for communicating, transmitting, sending or outputting for transmission may include the one or more transceivers 324, one or more antenna 322 and/or processing system 316 of the UE 304 illustrated in FIG. 3, transceiver 1085 and/or antenna 1090 of the communications device 1000 in FIG. 10, and/or one or more processors 1010 of the communications device 1000 in FIG. 10. Means for communicating, receiving or obtaining may include the one or more transceivers 324, one or more antennas 322, and/or processing system 316 of the UE 304 illustrated in FIG. 3, transceiver 1085 and/or antenna 1090 of the communications device 1000 in FIG. 10, and/or one or more processors 1010 of the communications device 1000 in FIG. 10.

### Example Clauses

Implementation examples are described in the following numbered clauses:
Clause 1: A method for wireless communications by a UE comprising: receiving, at a RLC layer, an RLC SDU; providing an initial transmission of an RLC PDU, including the RLC SDU, wherein providing the RLC PDU is associated with a start of a prohibit timer; and providing, autonomously and after a termination of the prohibit timer, a retransmission of the RLC PDU.
Clause 2: The method of Clause 1, wherein providing, autonomously, the retransmission of the RLC PDU comprises providing the retransmission based on remaining time of a retransmission timer being lower than a threshold.
Clause 3: The method of Clause 2, wherein providing, autonomously, the retransmission of the RLC PDU comprises providing the retransmission without having received a negative acknowledgment for the RLC PDU.
Clause 4: The method of Clause 2, wherein providing, autonomously, the retransmission of the RLC PDU comprises providing the retransmission without having transmitted a poll message for the RLC PDU.
Clause 5: The method of Clause 2, further comprising starting the retransmission timer upon receiving the RLC SDU at the RLC layer.
Clause 6: The method of Clause 2, wherein the retransmission timer is associated with a delay budget of the RLC SDU.
Clause 7: The method of Clause 2, wherein the threshold is associated with a HARQ process time of the UE.
Clause 8: The method of Clause 2, wherein providing the retransmission of the RLC PDU comprises waiting until the termination of the prohibit timer, while the remaining time of the retransmission timer is lower than the threshold, to provide the retransmission of the RLC PDU.
Clause 9: The method of Clause 2, wherein the retransmission timer is specific to the RLC SDU.
Clause 10: The method of Clause 2, further comprising canceling the retransmission timer in accordance with a positive acknowledgment of the RLC SDU.
Clause 11: The method of any one of Clauses 1-10, further comprising terminating the prohibit timer in accordance with a number of HARQ failures satisfying a second threshold.
Clause 12: The method of any one of Clauses 1-11, wherein the prohibit timer is specific to the RLC PDU.
Clause 13: One or more apparatuses, comprising: one or more memories comprising executable instructions; and one or more processors configured to execute the executable instructions and cause the one or more apparatuses to perform a method in accordance with any one of Clauses 1-12.
Clause 14: One or more apparatuses configured for wireless communications, comprising: one or more memories; and one or more processors, coupled to the one or more memories, configured to cause the one or more apparatuses to perform a method in accordance with any one of Clauses 1-12.
Clause 15: One or more apparatuses configured for wireless communications, comprising: one or more memories; and one or more processors, coupled to the one or more memories, configured to perform a method in accordance with any one of Clauses 1-12.
Clause 16: One or more apparatuses, comprising means for performing a method in accordance with any one of Clauses 1-12.
Clause 17: One or more non-transitory computer-readable media comprising executable instructions that, when executed by one or more processors of one or more apparatuses, cause the one or more apparatuses to perform a method in accordance with any one of Clauses 1-12.
Clause 18: One or more computer program products embodied on one or more computer-readable storage media comprising code for performing a method in accordance with any one of Clauses 1-12.
Clause 19: One or more apparatuses configured for wireless communications, comprising: a processing system that includes one or more processors and one or more memories coupled with the one or more processors, the processing system configured to cause the one or more apparatuses to perform a method in accordance with any one of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications at a user equipment (UE), comprising:
one or more antennas; and
a processing system that includes processor circuitry and memory circuitry that stores code for the processor circuitry, the processing system configured to cause the UE to:
receive, at a radio link control (RLC) layer, an RLC service data unit (SDU);
provide an initial transmission of an RLC PDU, including the RLC SDU, wherein providing the RLC PDU is associated with a start of a prohibit timer; and
provide, autonomously and after a termination of the prohibit timer, a retransmission of the RLC PDU.

2. The apparatus of claim 1, wherein to cause the UE to provide, autonomously, the retransmission of the RLC PDU, the processing system is configured to cause the UE to provide the retransmission based on remaining time of a retransmission timer being lower than a threshold.

3. The apparatus of claim 2, wherein to cause the UE to provide, autonomously, the retransmission of the RLC PDU, the processing system is configured to cause the UE to provide the retransmission without having received a negative acknowledgment for the RLC PDU.

4. The apparatus of claim 2, wherein to cause the UE to provide, autonomously, the retransmission of the RLC PDU, the processing system is configured to cause the UE to provide the retransmission without having transmitted a poll message for the RLC PDU.

5. The apparatus of claim 2, wherein the processing system is configured to cause the UE to start the retransmission timer upon receiving the RLC SDU at the RLC layer.

6. The apparatus of claim 2, wherein the retransmission timer is associated with a delay budget of the RLC SDU.

7. The apparatus of claim 2, wherein the threshold is associated with a hybrid automatic repeat request (HARQ) process time of the UE.

8. The apparatus of claim 2, wherein to cause the UE to provide the retransmission of the RLC PDU, the processing system is configured to cause the UE to wait until the termination of the prohibit timer, while the remaining time of the retransmission timer is lower than the threshold, to provide the retransmission of the RLC PDU.

9. The apparatus of claim 2, wherein the retransmission timer is specific to the RLC SDU.

10. The apparatus of claim 2, wherein the processing system is configured to cause the UE to cancel the retransmission timer in accordance with a positive acknowledgment of the RLC SDU.

11. The apparatus of claim 1, wherein the processing system is configured to cause the UE to terminate the prohibit timer in accordance with a number of hybrid automatic repeat request (HARQ) failures satisfying a second threshold.

12. The apparatus of claim 1, wherein the prohibit timer is specific to the RLC PDU.

13. A method for wireless communications by a user equipment (UE) comprising:
receiving, at a radio link control (RLC) layer, an RLC service data unit (SDU);
providing an initial transmission of an RLC PDU, including the RLC SDU, wherein providing the RLC PDU is associated with a start of a prohibit timer; and
providing, autonomously and after a termination of the prohibit timer, a retransmission of the RLC PDU.

14. The method of claim 13, wherein providing, autonomously, the retransmission of the RLC PDU comprises providing the retransmission based on remaining time of a retransmission timer being lower than a threshold.

15. The method of claim 14, wherein providing, autonomously, the retransmission of the RLC PDU comprises providing the retransmission without having received a negative acknowledgment for the RLC PDU.

16. The method of claim 14, wherein providing, autonomously, the retransmission of the RLC PDU comprises providing the retransmission without having transmitted a poll message for the RLC PDU.

17. The method of claim 14, further comprising starting the retransmission timer upon receiving the RLC SDU at the RLC layer.

18. The method of claim 14, wherein the retransmission timer is associated with a delay budget of the RLC SDU.

19. The method of claim 14, wherein the threshold is associated with a hybrid automatic repeat request (HARQ) process time of the UE.

20. An apparatus for wireless communications, comprising:
means for receiving, at a radio link control (RLC) layer, an RLC service data unit (SDU);
means for providing an initial transmission of an RLC PDU, including the RLC SDU, wherein providing the RLC PDU is associated with a start of a prohibit timer; and
means for providing, autonomously and after a termination of the prohibit timer, a retransmission of the RLC PDU.
